(19) United States
(12) Patent Application Publication
(10) Pub. No.: US 2022/0037891 A1
(43) Pub. Date: Feb. 3, 2022

(54) ENERGY-SAVING OPERATION FOR AN ENERGY SUPPLY SYSTEM WITH BATTERY STORAGE

(71) Applicant: instagrid GmbH, Ludwigsburg (DE)

(72) Inventors: Sebastian Berning, Stuttgart (DE); Andreas Sedlmayr, Pforzheim (DE)

(21) Appl. No.: 17/502,961

(22) Filed: Oct. 15, 2021

Related U.S. Application Data
(63) Continuation of application No. PCT/EP2020/060863, filed on Apr. 17, 2020.

(30) Foreign Application Priority Data
Apr. 17, 2019 (DE) 10 2019 110 177.8

(51) Int. Cl. H02J 7/00; B60R 16/033

(52) U.S. Cl. CPC H02J 7/0013; B60R 16/033; H02J 7/0048

(57) ABSTRACT

A mobile energy supply system having: a plurality of battery modules that can be connected in series in a controllable manner to supply different voltages at an output of the energy supply system, a control unit for activating the battery modules, each of which includes a battery unit and a bridge circuit which is provided between the module's input and output connections and is designed either to connect the battery unit to the input and output connections (battery mode) or to connect the input connection to the output connection by bypassing the battery unit (bypass mode). Each battery module is designed to be controlled in an operating mode and an idle mode, wherein in the operating mode the bridge circuit can be switched into the battery mode and the bypass mode, and in the idle mode the bridge circuit is placed in a state with minimum energy consumption.

### CROSS REFERENCES TO RELATED APPLICATIONS

This application is a continuation of international patent application no. PCT/EP2020/060863 filed on Apr. 17, 2020 and published in German language as WO 2020/212572 A1, which international patent application claims priority from German patent application DE 10 2019 110 177 filed on Apr. 17, 2019.

### TECHNICAL FIELD

The present invention relates to a mobile energy supply system having a plurality of battery modules that can be connected in series in a controllable manner to supply different voltages at an output of the energy supply system, a control unit for activating the battery modules, each battery module having an input and an output connection, a battery unit and a bridge circuit, which is provided between the input and output connections and designed either to connect the battery unit to the input and output connection (battery mode) or to connect the input connection to the output connection by bypassing the battery unit (bypass mode).

### BACKGROUND ART

Stationary energy supply systems of the above type are generally known, for example also from U.S. Pat. No. 5,642,275 A or U.S. Pat. No. 3,867,643 A.

The energy supply systems shown there use converters, commonly referred to as “cascaded multilevel inverters/converters” or “multilevel inverter/converters”. Other energy supply systems are shown in DE 10 2014 200 267 A1, US 2016/0075254 A1 or US 2015/0171632 A1.

The principle of these converters is to control a number N of individual DC voltage sources in such a way that a voltage rising or decreasing in a step-like manner is produced at the output so that an almost sinusoidal alternating voltage is obtained which can be smoothed if necessary.

In comparison to so-called two- or three-point converters, which generate a single- or three-phase sinusoidal output voltage from a DC link voltage by means of chopping and smoothing, such converters have proved to be advantageous, in particular with regard to costs, thermal losses and unit size.

In the stationary operation of such energy supply systems, in an idle state, i.e. during transport or storage without connected consumers, the energy consumption does not play a significant role as there is usually a permanent connection to an external supply network. However, if such energy supply systems are to be operated as mobile systems, the problem arises that the battery cells that supply energy to the electrical components in the system will discharge over time. In this connection, for example, mobile systems can also be understood to include systems that can be used to supply vehicles.

Against this background, an object of the present invention is to further develop the energy supply system of the above-mentioned kind in such a way that it can be used as a mobile system, i.e. a rapid discharge of the battery cells is avoided.

### SUMMARY

This object is achieved in the mobile energy supply systems of the above-mentioned type by the fact that each battery module is designed to be controlled in an operating mode and an idle mode, wherein in the operating mode the bridge circuit can be switched to the battery mode and the bypass mode, and in the idle state the bridge circuit is placed in a state with minimum energy consumption.

The object may be thereby fully solved.

The fact that each battery module can be controlled, preferably via a control signal, into an idle mode significantly reduces the energy consumption within the battery module. In particular, the energy consumption of the bridge circuit is reduced since it is set into a state with minimum energy consumption.

In order to achieve this state with minimum energy consumption, at least some of the electronic components within the bridge circuit are operated in such a way that they have no or minimal energy consumption.

A preferred way to bring about such an idle state with minimal energy consumption in a bridge circuit is to design the plurality of switching elements for setting the battery mode or the bypass mode as self-blocking switching elements, such as N-MOSFETs, and to put them into the self-blocking state. Such a self-blocking state can be achieved without the need to supply energy to the switching elements. In this state, the battery unit is neither connected to the input and output connections of a bridge connection, nor are the input connection and output connection connected by bypassing the battery unit.

Because these switching elements consume minimal or no energy, the total energy consumption of the bridge circuit can be significantly reduced.

Each battery module is preferably equipped with a control device which is connected to the battery unit for energy supply and to the bridge circuit in order to switch the bridge circuit into the battery mode or the bypass mode. In other words, the control device generates the control signal. Alternatively, this control signal could conceivably be delivered directly by the control unit.

This measure has the advantage that the control unit can send, e.g., a coded signal with a plurality of information items to all battery modules, and the control unit then decodes this signal and converts it into the control signal.

In a preferred embodiment, in the idle mode the control device is at least intermittently placed in a state with minimum energy consumption.

In other words, not only is the energy consumption of the bridge circuit reduced but also that of the control device of a battery module, resulting in an even greater reduction of the energy consumption. The fact that the control device operates intermittently, in particular periodically, in a state with normal energy consumption during the idle mode does not cause the control function of the control device to be lost during the idle mode. This means that the control device of a battery module can also transfer the bridge circuit from the idle state into the operating mode during the idle mode.

In a preferred embodiment, each battery module is assigned an isolation device which provides galvanic isolation between the battery module and the control unit.

This isolation device can be used to transmit signals from the control unit to a battery module in an electrically isolated manner. Such electrical isolation is necessary, particularly from a safety perspective. At this point it should be noted that the isolation device does not necessarily need to form a structural unit with the battery module. It is also conceivable to design the isolation device as a separate unit from the battery module.

The isolation device is preferably connected at least partially and/or at least intermittently to the battery unit to supply energy, even in the idle state. Preferably, the isolation device is connected to the battery unit at predefined intervals in the idle state to supply energy.

In other words, a part of the isolation device is supplied with energy by the battery unit, wherein this energy supply can be at least intermittently interrupted, for example at predefined intervals, in order to further reduce the energy consumption without restricting the functionality of the isolation device. In other words, this means that even in the idle mode the isolation device can receive signals from the control unit and forward them accordingly. Control signals from the control unit can be received and forwarded during the idle mode during those periods in which the isolation device is temporarily connected to the battery unit.

Implementing the above measures, namely reducing the energy consumption of the bridge circuit, the control device and the isolation device, can considerably reduce the energy consumption of a battery module during the idle mode.

In a preferred embodiment, a battery module is placed in the idle mode when a specified criterion is reached. Such a criterion can be, for example: absence of a control signal from the control unit in the bypass mode, or a mean current output below a specified value.

In other words, the idle mode does not need to be set manually, but instead the energy system automatically selects this idle mode. The advantage of this measure is in particular that it is possible to further reduce the energy consumption as the idle mode is selected reliably and quickly. If possible, each battery module is in idle mode.

In a preferred embodiment, the isolation device comprises a radio receiver, and/or an optical sensor and/or a capacitive or inductive transmitter for galvanic isolation.

The use of so-called opto-couplers is a particularly cost-effective way of providing galvanic isolation between the battery module and the control unit.

In a preferred embodiment, the control signal supplied by the control unit to the battery modules contains at least two items of information, namely bypass mode or battery mode and idle mode or operating mode. The control unit is preferably designed to generate a time-coded binary signal as the control signal.

These measures have proved to be particularly advantageous since only a very small amount of effort is required to transmit the control signals.

In a preferred embodiment, each battery module comprises an isolation device designed to isolate the bridge circuit and/or at least one DC link capacitor from the battery unit, wherein the DC link capacitor is provided in parallel with the battery unit. More preferably, the isolating device comprises at least one switching element, wherein in the idle mode this at least one switching element is placed in a state with minimum energy consumption, preferably in a high-resistance state.

In a preferred embodiment, at least one of the switching elements is designed as a transistor.

More preferably, the battery unit comprises at least one battery cell. Of course, the battery unit can also comprise a plurality of battery cells connected in series or in parallel.

In a preferred embodiment the battery unit comprises a circuit for measuring individual voltages of series-connected battery cells of the battery unit, which circuit in the idle mode is placed in a state with minimum energy consumption.

The object of the invention may be also solved by a battery module for an energy supply system, wherein the battery module comprises: an input and an output connection, a battery unit, a bridge circuit provided between the input and output connections, which is designed either to connect the battery unit to the input and output connection (battery mode) or to connect the input connection to the output connection by bypassing the battery unit (bypass mode), wherein the battery module is designed to be controlled in an operating mode and an idle mode, wherein in the operating mode the bridge circuit can be switched to the battery mode and the bypass mode, and in the idle mode the bridge circuit is placed in a state with minimum energy consumption.

The aforementioned features and those yet to be explained below can be applied not only in the corresponding specified combination, but also in other combinations or in isolation without departing from the scope of the present invention.

### BRIEF DESCRIPTION OF DRAWINGS

Further advantages and embodiments of the invention are derived from the description and the enclosed drawings. In the drawings:

FIG. 1 shows a schematic illustration of a mobile energy supply system;

FIG. 2 shows a schematic illustration of a battery module of the energy supply system of FIG. 1;

FIG. 3a shows a schematic illustration of a bridge circuit of the battery module of FIG. 2 according to a first alternative;

FIG. 3b shows a schematic illustration of a bridge circuit of the battery module of FIG. 2 according to a second alternative;

FIG. 4 shows a schematic illustration of an isolation device of the battery module of FIG. 2;

FIG. 5 shows two different embodiments of an isolating device of the battery module of FIG. 2; and

FIG. 6 shows a schematic illustration of a battery unit of the battery module of FIG. 2.

### DESCRIPTION OF EMBODIMENTS

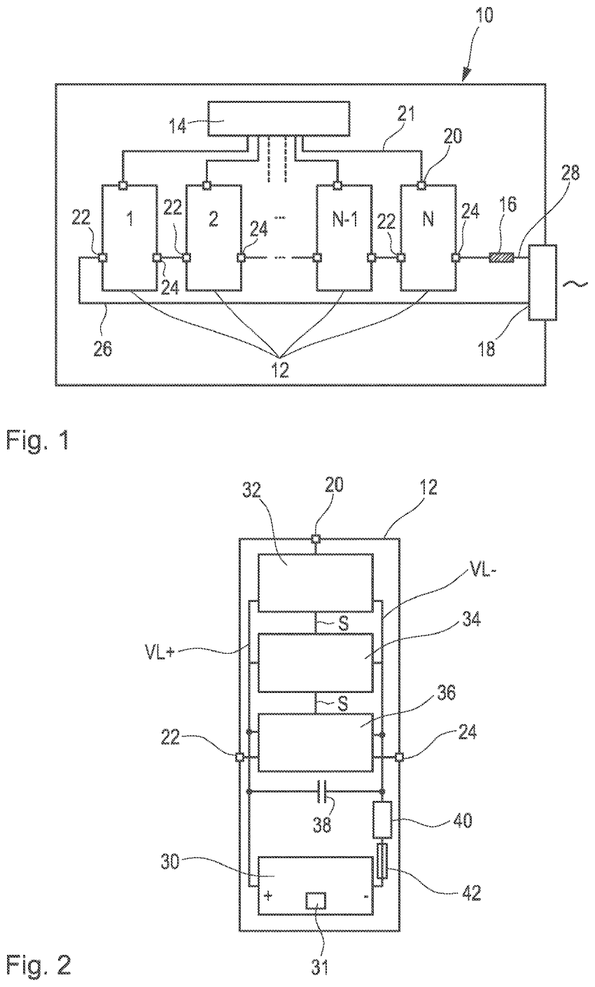

FIG. 1 shows an energy supply system as a block circuit diagram and labeled with the reference sign 10. This energy supply system 10 is designed as a mobile unit, i.e. it has a weight and a size that can be handled by one person. The weight of the energy supply system is less than 25 kilos and the size is chosen such that the energy supply system can be carried as a backpack.

The mobile energy supply system 10 comprises a number N of battery modules 12 that are connected in series. The individual battery modules 12 are controlled by means of a control unit 14.

The total voltage delivered by the battery modules 12 connected in series is smoothed via a smoothing choke and is applied to a plug device 18. The plug device 18 can be a standardized plug connector for, for example, 220 V AC voltage devices.

As shown in FIG. 1, each of the N battery modules 12 comprises a control connection 20, through which the control device 14 can transmit a control signal via a control line 21.

In addition, each battery module 12 has a module input 22 and a module output 24. At this point, however, it should be noted that “input” and “output” are arbitrarily identified. In particular, if the polarity of the battery module is controllable, “input” and “output” cannot be functionally distinguished from each other. Thus, by means of suitable actuation, two inputs 22 or outputs 24 can also be connected to each other in series.

The N battery modules are arranged in such a way that the module output 24 of a battery module 12 is electrically connected to the module input 22 of the following battery module 12. The module input 22 of the first battery module 12 is then electrically connected to the plug device 18 via a voltage line 26, and the module output 24 of the last battery module is connected to the plug device 18 via the smoothing choke 16, so that the delivered output voltage of the energy supply system 10 is present between the module input 22 of the first battery module and the module output 24 of the last battery module 12.

In order to achieve an approximately sinusoidal AC voltage at the output, the individual battery modules are controlled by the control unit 14 so as to switch periodically from a battery mode to a bypass mode and vice versa. In battery mode, the voltage of one battery unit of the battery module 12 is present between the module input 22 and module output 24 of a battery module. In bypass mode, however, the module input 22 and module output 24 are electrically connected to each other, so that there is no voltage between these points.

By successively switching the battery modules from the bypass mode into the battery mode, the output voltage can be increased in steps by the voltage of one battery module. By the same token, the output voltage can be gradually reduced again by successively switching back to the bypass mode. The possible voltages at the output are therefore between 0 V and N times the voltage of one battery module.

By smoothing this step-wise voltage characteristic, if at all necessary, an almost sinusoidal voltage characteristic can be achieved at the plug device 18.

It should be noted here, however, that it is of course also conceivable to switch a plurality of the N battery modules 12 between bypass mode and battery mode simultaneously. In addition, it should be noted that the generation of one half-wave has been described so far. The other half-wave is generated in the same way, with only a polarity change. For simplification purposes, this polarity change is not shown in the figures and is also not described further.

The basic structure of a battery module 12 is explained below with reference to FIG. 2.

A battery module 12 comprises a battery unit 30 comprising one or more battery cells, preferably rechargeable battery cells, and a battery cell monitoring unit 31. The battery cell monitoring unit 31 monitors the cell voltages of the individual battery cells. FIG. 6 shows an example of the battery unit 30 in detail. It comprises a number of N battery cells Z1 to ZN, which are connected in series. In addition, the battery cell monitoring unit 31 is connected to the individual cells Z1-ZN in such a way that the respective cell voltage can be detected. The battery cell monitoring unit 31 is supplied from the battery unit 30 itself, preferably via the two external taps, i.e. via the voltage VL+ and VL−.

In addition, the battery module 12 contains an isolation device 32, a control device 34, a bridge circuit 36, and a capacitor 38, which are arranged in parallel with each other and with the battery unit 30 and are electrically connected to the battery unit 30 via two supply lines VL+, VL−. In one or both supply lines VL+ and VL− an isolating device 40 and a fuse 42 connected in series are also provided.

FIG. 2 also shows that one input of the isolation device 32 is connected to the control connection 20 of the battery module 12 to enable a control signal to be received. Such a control signal can then be forwarded via a control line S from the isolation device to the control device 34. From the control device 34, a control signal can in turn be transmitted via a control line S to the bridge circuit 36.

As further shown in FIG. 2, the module input 22 and the module output 24 are each electrically connected to the bridge circuit 36.

The bridge circuit 36 is now designed such that in battery mode it connects the voltage line VL+ to the module input and connects the voltage line VL− to the module output 24. This means that the voltage provided by the battery unit, for example 3.6 V for a lithium-ion cell, is applied to the module input 22 and the module output 24.

In the bypass mode, however, the bridge circuit 36 creates an electrical connection between the module input 22 and the module output 24, so that the battery unit 30 is disconnected and the battery module 12 itself does not supply any voltage between the module input and module output.

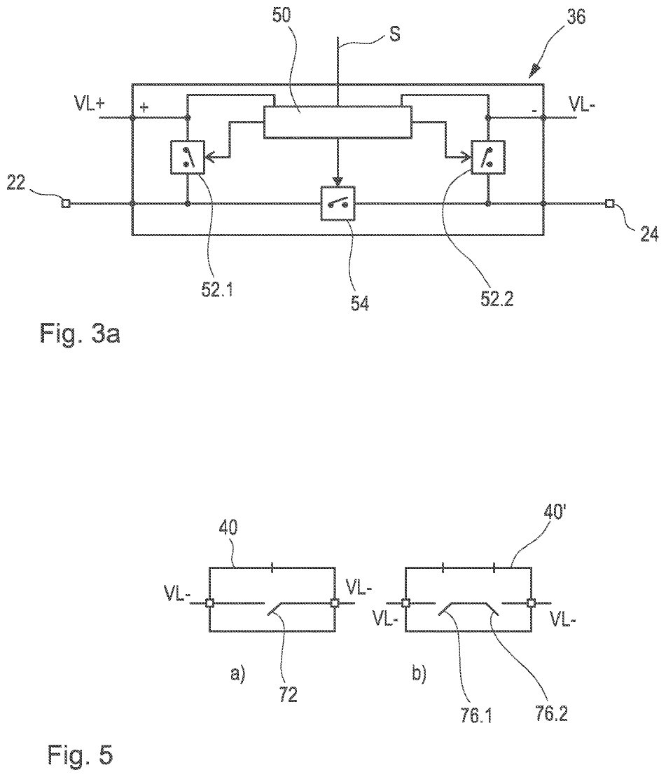

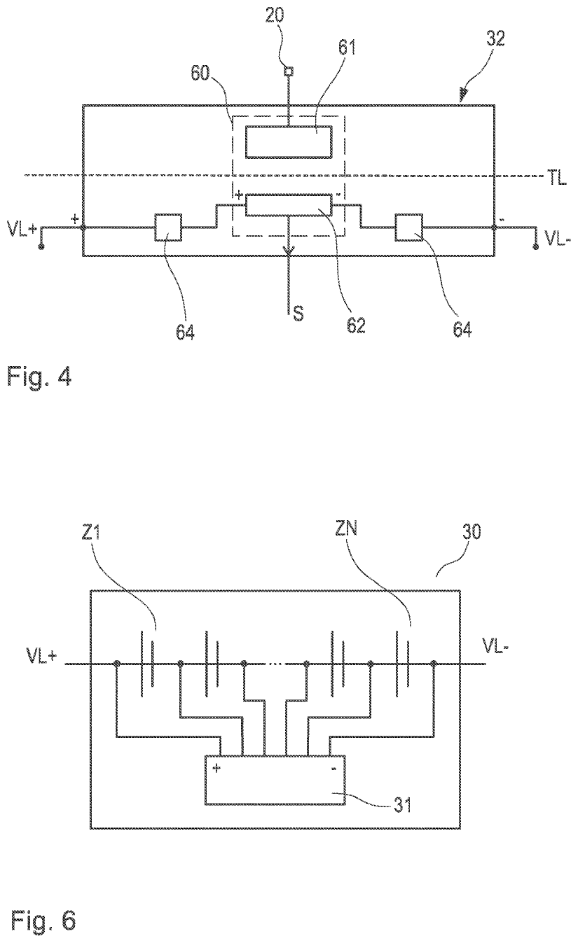

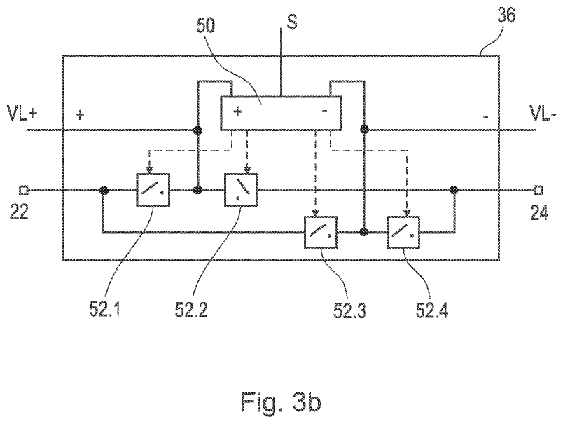

Examples of the structure of two different bridge circuits 36 are shown schematically in FIG. 3a and FIG. 3b. It should be noted that the individual switching elements shown are solely intended to clarify the functionality of the bridge circuit.

In FIG. 3a, the bridge circuit 36 comprises a switch controller 50, which can control a total of three switching elements 52.1, 52.2 and 54, for example. The two switching elements 52.1 and 52.2 each create a connection between the supply line VL+ and the module input 22 or the supply line VL− and the module output 24.

The switching element 54 is provided between the module input 22 and the module output 24 and can create an electrical connection between these two points.

In the battery mode, the two switching elements 52.1 and 52.2 are now closed, while the switching element 54 must be open.

In the bypass mode, the switching element 54 is closed, while at least one of the other two switching elements 52.1 and 52.2 must be open to ensure the bypass.

The control of each of these switching elements is effected via the switch controller 50, which in turn receives the necessary control signals from the control device 34 via the control line S.

It is also evident from FIG. 3a that the switch controller 50 is supplied with energy from the battery unit 30 via the two supply lines VL+ and VL−.

Normally, the above-mentioned switching elements 52, 54 are provided as transistors, for example MOSFETs. Other switching elements are of course also conceivable.

FIG. 3b shows an alternative bridge circuit 36 which, in contrast to the bridge circuit described above, comprises a total of four switching elements 52.1, 52.2, 52.3 and 52.4, each of which can be activated by the switch controller 50. The two switching elements 52.1 and 52.2 are connected in series and are located in a first current path between module input 22 and module output 24. The other two switching elements 52.3 and 52.4 are also connected in series and are located in a second current path between module input 22 and module output 24, i.e. the two series circuits of the switching elements are in parallel.

There is also an electrical connection between the supply line VL+ and a tap between the two switching elements 51.1 and 52.2. An electrical connection is also present between the supply line VL− and a tap between the two switching elements 51.3 and 52.4.

The four switching elements 52.1 to 52.4 then allow four different states to be created, namely
a) a bypass mode in which, for example, the switching elements 52.3 and 52.4 are closed and the switching elements 52.1 and 52.2 are open;
(b) a battery mode with polarity 1, in which, for example, the switching elements 52.1 and 52.4 are closed and the switching elements 52.2 and 52.3 are open;
c) a battery mode with polarity 2, in which, for example, the switching elements 52.1 and 52.4 are open and the switching elements 52.2 and 52.3 are closed; and
d) an idle mode, in which all switching elements 52.1 to 52.4 are open.

With reference to FIG. 4, the isolation device 32 will now be explained in more detail. It comprises a device for galvanic isolation 60, which comprises a first device part 61 and a second device part 62, the two device parts 61, 62 being galvanically isolated as indicated by the separating line TL. Consequently, there is no electrical connection between these two device parts 61, 62. The above-mentioned galvanic isolation device can be implemented, for example, by means of an inductive coupling device, with the two device parts 61, 62 being implemented as coils, for example. However, the galvanic isolation device could also be implemented as an opto-coupler.

The isolation device 32 also comprises control elements 64, which in each case are provided in the electrical connection between the second device part 62 and the supply line VL+ or the supply line VL−. These control elements 64 can be used to isolate the second device part 62 from the supply voltage VL+, VL− in a controlled manner. Alternatively, it is also conceivable to provide only one control element 64 in one of the two connections. If the isolation device 32 itself has a very low or no idle current consumption, the control elements 64 can be omitted if necessary.

In the case of galvanic isolation using an opto-coupler, the function of this isolation device 32 is then to feed a control signal, transmitted by the control unit 14 via the control connection 20, to the first device part 61, which converts this control signal into an optical signal OS which in turn is detected by the second device part 62 and converted into an electrical control signal S. By converting an electrical signal into an optical signal and then back into an electrical signal, this galvanic isolation can be implemented very simply and cost-effectively.

As explained with reference to FIG. 1, the individual battery modules 12 are switched back and forth between a battery mode and a bypass mode in order to supply the desired AC voltage at the output. When switching between battery mode and bypass mode in this way, different control elements are required in the respective battery modules 12, each of which is supplied with energy from the battery-module-internal battery unit 30.

As can be seen from FIGS. 3a, b and 4, for example, the switch controller 50 and the switching elements 52, 54, as well as the second device part 62 and the control elements 64, are supplied with energy via the battery unit.

The problem with this is that this energy supply is also provided when no load is connected to the output. Even if all battery modules 12 are in the bypass mode, so that the output voltage is 0 V, the individual components in both the isolation device 32 and the bridge circuit 36 are still supplied with energy.

Especially in the case of an energy supply system for mobile use, which is not permanently connected to an external energy supply, this energy consumption leads to a discharge of the respective battery units of the battery modules so that the energy supply system 10 can no longer be used after a certain period of time. Under certain circumstances, this energy consumption may even lead to a deep discharge of the individual battery units, which significantly degrades their service life.

It is therefore an objective of the present invention to reduce this energy consumption in time periods in which, for example, no load is to be supplied.

The battery modules 12 are therefore designed such that, in addition to a normal operating mode in which the operating mode is switched back and forth between the bypass mode and the battery mode, an idle mode is provided in which at least the bridge circuit can be placed in a state with minimum energy consumption.

If the bridge circuit is in this idle mode, the switching elements 52, 54 are transferred to the open state so that the module input is connected neither to the module output 24 nor to the supply line VL+. Alternatively, or additionally, the module output 24 is not connected to the supply line VL− either.

In this state, the switching elements 52, 54, which are preferably implemented as transistors, consume significantly less energy, resulting in the energy consumption of the bridge circuit 36 being reduced.

It is also possible to disconnect the switch controller 50 from the energy supply, i.e. both supply lines VL+, VL−, in the idle mode. However, it is necessary for the switch controller 50 to be able to detect a control signal from the control device 34, or alternatively directly from the isolation device 32, which reverts the bridge circuit from the idle mode to the operating mode. This can be ensured by periodically switching the switch controller 50 back and forth between a state with low energy consumption and a state in which a control signal S can be detected. With an appropriate design of the switch controller 50, instead of disconnecting it from the supply lines it would also be conceivable to merely activate a standby mode in which the switch controller requires a negligible idle current. In this case, the received control signal would transfer the switch controller 50 to the standby mode.

In order to further reduce energy consumption, the isolation device 32 can also be switched to a state with lower energy consumption during the idle mode. For this purpose, the switching elements 64 are provided, which at least intermittently interrupt the energy supply, i.e. the connection of the second device part 62 to the respective supply line VL+ or VL−. This, for example periodic, switching of the second device part 62 on and off ensures that control signals can be received from the control unit 14.

The two switching elements 64 themselves receive a corresponding control signal from the control unit 14 to switch between operating mode and idle mode.

Such a control signal for activating the idle mode or the operating mode is also transmitted to the control device 34 and the bridge circuit 36 via the isolation device 32.

Although it is not intended to discuss the control device 34, it goes without saying that appropriate precautions can also be taken here to place certain components in a state with low energy consumption during the idle mode. Here also, it must be ensured that the control device 34 is able to detect a control signal for switching from the idle mode to the operating mode. In other words, the components required to receive such a control signal are at least intermittently transferred from the state with minimum energy consumption into the state required for the detection of the signal. The control device 34 itself is responsible for switching the battery module 12 from the bypass mode to the battery mode and back at the correct times. For this purpose, the control device 34 evaluates the signal coming from the control unit accordingly. This signal coming from the control unit 14 can contain two items of information, for example, battery mode or bypass mode, and operating mode or idle mode.

Overall, the result obtained is that the individual measures described above for reducing energy consumption overall make it possible to significantly reduce the total energy consumption in the idle mode.

A further improvement in the energy consumption can then be achieved by placing each battery module 12 into the idle mode whenever no load is connected to the plug connector 18 or, for example, the mean current output is below a specified value. Other criteria for switching to the idle mode are of course conceivable. A staggered switchover of the bridge circuit 36, the control device 34 and isolation device 32 to the idle mode depending on different criteria would also be possible.

Overall, however, it is important that all battery modules 12 can be reset from the idle mode to the operating mode by a control signal from the control unit 14. For this reason, it is necessary that at least individual electrical components continue to be supplied with energy from the battery unit 30, at least intermittently, in order to be able to receive and evaluate this control signal from the control unit 14. However, this “reception capability” of isolation device 32, control device 34 and bridge circuit 36 during the idle mode does not, as described, need to be continuously present. It is sufficient to provide this reception capability at least intermittently during the idle mode.

Tests have shown that the energy consumption during an idle mode can be significantly reduced by more than a factor of 10. If all the above measures are taken, the reduction factor for the energy consumption can be significantly increased, for example, to 100 or more.

As already explained with reference to FIG. 2, the supply line VL− contains the isolating device 40 and the fuse 42. The fuse 42 is provided to isolate the battery if the current flow is too high. Alternatively, the isolating device 40 and/or the fuse 42 can also be provided in the supply line VL+.

The isolation device 40 is provided to isolate the battery unit 30 from one or more of the other components as necessary, such as the isolation device 32, control device 34, bridge circuit 36, and capacitor 38. This isolation can be controlled, for example, via a control signal from the control unit 14. In the present case, all components are isolated. However, it is also conceivable, for example, to disconnect only the bridge circuit 36 from the battery unit.

The isolation device 40 itself, as shown in FIG. 5a, comprises, for example, a switching element 72, e.g. in the form of a MOSFET transistor.

Alternatively, as shown in FIG. 5B, the isolating device 40 can comprise two switching elements 76.1, 76.2, which are connected in series.

Overall, it is clear that the energy supply system according to the invention has a significantly reduced energy consumption, which means that it can also be used in particular as a mobile unit which remains ready for use even over a fairly long period of time without a mains connection. Such mobile use was not possible with previous energy supply systems such as those specified in the above-mentioned prior art, because the battery units were discharged very quickly.

1. A mobile energy supply system comprising:
a plurality of battery modules that can be connected in series in a controllable manner to supply different voltages at an output of the energy supply system, and
a control unit for activating the battery modules,
wherein each battery module comprises:
an input connection and an output connection,
a battery unit, and
a bridge circuit which is provided between the input connection and the output connection and is designed either to connect the battery unit to the input and output connection (battery mode) or to connect the input connection to the output connection by bypassing the battery unit (bypass mode), and
wherein each battery module is designed to be controlled in an operating mode and an idle mode, wherein in the operating mode the bridge circuit can be switched into the battery mode and the bypass mode, and in the idle mode the bridge circuit is placed in a state with minimum energy consumption.

2. The energy supply system as claimed in claim 1, further comprising a control device which is connected to the battery unit for energy supply and to the bridge circuit in order to switch the bridge circuit into the battery mode or the bypass mode.

3. The energy supply system as claimed in claim 1, wherein the bridge circuit comprises a plurality of self-blocking switching elements for setting the battery mode or the bypass mode, wherein in the idle mode the switching elements of the bridge circuit are placed in a state with minimum energy consumption.

4. The energy supply system as claimed in claim 3, wherein the switching elements are placed in the blocking state.

5. The energy supply system as claimed in claim 1, wherein in the idle mode the control device is at least intermittently placed in a state with minimum energy consumption.

6. The energy supply system as claimed in claim 1, wherein the control unit is designed to direct a control signal to at least one of the battery modules to activate the operating mode or the idle mode.

7. The energy supply system as claimed in claim 1, wherein each battery module comprises an isolation device which provides galvanic isolation between the battery module and the control unit.

8. The energy supply system as claimed in claim 7, wherein the isolation device is connected at least partially and/or at least intermittently to the battery unit to supply energy, even in the idle mode.

9. The energy supply system as claimed in claim 8, wherein the isolation device is connected to the battery unit at predefined intervals in the idle mode to supply energy.

10. The energy supply system as claimed in claim 1, wherein a battery module is placed in the idle mode when a specified criterion is reached.

11. The energy supply system as claimed in claim 10, wherein the criterion is selected from: absence of a control signal from the control unit in bypass mode, or mean current output below a specified value, or charge state/voltage of at least one battery module below a specifiable value.

12. The energy supply system as claimed in claim 1, wherein the isolation device comprises a radio receiver and/or an optical sensor and/or a capacitive or inductive transmitter for galvanic isolation.

13. The energy supply system as claimed in claim 1, wherein the control signal supplied by the control unit contains at least two items of information, namely bypass mode or battery mode, and idle mode or operating mode.

14. The energy supply system as claimed in claim 13, wherein the control unit is designed to generate a time-coded binary signal as the control signal.

15. The energy supply system as claimed in claim 1, wherein each battery module has an isolating device which is designed to disconnect the bridge circuit and/or a DC link capacitor from the battery unit, the DC link capacitor being provided in parallel with the battery unit.

16. The energy supply system as claimed in claim 15, wherein the isolating device comprises at least one switching element, and that in the idle mode this at least one switching element is placed in a state with minimum energy consumption, preferably in a high-resistance state.

17. The energy supply system as claimed in claim 1, wherein the battery unit comprises at least one battery cell.

18. The energy supply system as claimed in claim 1, wherein at least one of the switching elements is implemented as a transistor.

19. The energy supply system as claimed in claim 1, wherein the control device comprises a circuit for measuring individual voltages of series-connected battery cells of the battery unit, which circuit is placed in a state with minimum energy consumption in the idle mode.

20. The energy supply system as claimed in claim 1, wherein it is designed for use in a vehicle.

21. A battery module for an energy supply system, wherein the battery module comprises:
an input connection and an output connection,
a battery unit, and
a bridge circuit, which is provided between the input connection and the output connection and is designed either to connect the battery unit to the input and output connections (battery mode) or to connect the input connection to the output connection by bypassing the battery unit (bypass mode),
wherein the battery module is designed to be controlled in an operating mode and an idle mode, wherein in the operating mode the bridge circuit can be switched to the battery mode and the bypass mode, and in the idle mode the bridge circuit is placed in a state with minimum energy consumption.
